(19) United States
(12) Patent Application Publication
(10) Pub. No.: US 2015/0348487 A1
(43) Pub. Date: Dec. 3, 2015

(54) Electronic Device Display With Display Driver Power-Down Circuitry

(71) Applicant: Apple Inc., Cupertino, CA (US)

(72) Inventors: Fenghua Zheng, San Jose, CA (US); Andrew P. Aitken, Sunnyvale, CA (US)

(21) Appl. No.: 14/501,432

(22) Filed: Sep. 30, 2014

Related U.S. Application Data
(60) Provisional application No. 62/006,667, filed on Jun. 2, 2014.

(51) Int. Cl. G09G 3/36

(52) U.S. Cl. CPC G09G 3/3696; G09G 3/3648; G09G 2330/04; G09G 2330/027; G09G 2310/0297

(57) ABSTRACT

Display driver circuitry loads data into display pixels. A regulator produces a power supply voltage for display driver circuitry that is measured by a monitor circuit. The monitor circuit asserts a mode selection signal in response to detection of a drop in power supply voltage during a power-down event. The display driver circuitry contains mode selection circuitry that is controlled by the mode selection signal. The mode selection circuit allows a controlled parallel driver shutdown sequence. During normal operation, the mode selection signal is deasserted and the display driver circuitry loads image data for the display into the display pixels. When the mode selection signal is asserted, mode selection circuitry and other circuitry in the display driver circuitry continue to operate during the power down so as to load safe data into the display pixels to avoid damaging the display when the display has been powered off.

This application claims the benefit of provisional patent application No. 62/006,667 filed Jun. 2, 2014, which is hereby incorporated by reference herein in its entirety.

### BACKGROUND

This relates generally to electronic devices and, more particularly, to electronic devices with displays.

Electronic devices often include displays. For example, cellular telephones, computers, and televisions have displays.

Displays such as liquid crystal displays have arrays of display pixels. Display driver circuitry is used to display images on a display by loading image data into an array of display pixels. The display driver circuitry includes column drivers for supplying data to columns of the display pixels and includes gate driver circuitry for addressing rows of the display pixels. When displaying a frame of data on the display, the gate driver circuitry successively asserts a gate signal in each row of the array to load data into the display pixels.

There are challenges involved in preventing damage to a display when powering down the display. In displays that contain somewhat leaky thin-film transistors, display pixels naturally discharge when the display is powered down. In other displays, however, such as displays based on oxide semiconductor thin-film transistors, the amount of transistor leakage that is exhibited by thin-film transistors in the display pixels is reduced. If care is not taken, this may lead to undesired persistent pixel voltages after powering down the display. For example, display pixel signals of several volts or more may remain on the display pixels once the display is no longer being refreshed during normal operation. Sustained display pixel voltages such as these may cause image retention or permanent damage to the display. In some cases, the most recently displayed image on a display may become effectively burned into the display during power-down and may be subsequently visible for many hours of subsequent operation once the display has been powered-up and used again.

It would therefore be desirable to be able to provide improved ways to power down display pixels in a display.

### SUMMARY

A display may have an array of display pixels. Display driver circuitry may be used to load data into the display pixels. The display driver circuitry may include column driver circuitry for supplying data signals to columns of the display pixels. The display driver circuitry may also include gate driver circuitry for supplying gate signals that are used in sequentially addressing rows of the display pixels.

The display may include a regulator that produces a power supply voltage for the display driver circuitry. A monitor circuit may measure the power supply voltage. During a power-down event, the power supply voltage will drop. The monitor circuit may assert a mode selection signal in response to detection of a drop in the power supply voltage below a predetermined threshold.

The display driver circuitry may contain mode selection circuitry that is controlled by the mode selection signal. During normal operation, the mode selection signal is deasserted and the display driver circuitry loads image data for the display in to the display pixels. During power-down operations, when the mode selection signal is asserted, the mode selection circuitry and other circuitry in the display driver circuitry may load safe data into the display pixels to avoid damaging the display while the display is powered off.

### BRIEF DESCRIPTION OF THE DRAWINGS

FIG. 1 is a perspective view of an illustrative electronic device such as a laptop computer with a display in accordance with an embodiment.

FIG. 2 is a perspective view of an illustrative electronic device such as a handheld electronic device with a display in accordance with an embodiment.

FIG. 3 is a perspective view of an illustrative electronic device such as a tablet computer with a display in accordance with an embodiment.

FIG. 4 is a perspective view of an illustrative electronic device such as a display for a computer or television with display structures in accordance with an embodiment.

FIG. 5 is a cross-sectional side view of an illustrative display in accordance with an embodiment.

FIG. 6 is a circuit diagram of an illustrative display pixel in a display pixel array in a display of the type shown in FIG. 5 in accordance with an embodiment.

FIG. 7 is a diagram of an illustrative display showing display driver circuitry that may be used to present images on an array of display pixels during normal operation and that may be used to load safe data into the array of display pixels during a power down event in accordance with an embodiment.

FIG. 8 is a circuit diagram of control and display driver circuitry for a display in accordance with an embodiment.

FIG. 9 is a flow chart of illustrative steps involved in using the circuitry of FIG. 8 when operating a display during a power-down event in accordance with an embodiment.

FIG. 10 is a circuit diagram showing a mode selection circuit of the type that may be used to control application of gate driver control signals to gate driver circuitry in a display during normal operation and during power-down operations in accordance with an embodiment.

FIG. 11 is a circuit diagram of an illustrative gate driver circuit in accordance with an embodiment.

FIG. 12 is a graph showing gate driver control signals that may be used during normal operation and during power-down operation of a display in accordance with an embodiment.

FIG. 13 is a diagram showing illustrative gate signal patterns that may be used when loading safe data signals into an array of display pixels during power down operations in a display in accordance with an embodiment.

### DETAILED DESCRIPTION

Electronic devices may be provided with displays. Display driver circuitry such as column driver circuitry and gate driver circuitry may be used in displaying images on an array of display pixels in a display. During an intentional power-down event or when powering down a display due to an unexpected power supply disruption, permanent damage to the display may be avoided by ensuring that each display pixel is driven to a safe voltage. For example, in a display in which display pixels are driven between 7.5 volts and 15 volts (during frames of one polarity) and between 0 and 7.5 volts (during frames of an alternate polarity) on one electrode, and driven at a constant 7.5 volts on the other pixel electrode, the power-down operations are performed so that the voltage across the pixel between the two electrodes is maintained at or near 0 volts during the power down, rather than allowing the unmodified data values for the display pixels to be driven during the power down. The data values during power down on one electrode might otherwise cause relatively high voltages such as 7.5 volts relative to the second electrode to occur across the pixel during power down that could potentially then damage the display if left in place during and following the power down. Display driver circuitry may instead therefore be used to drive safe data (i.e., signals at a desired safe voltage that keeps the pixel voltage itself low) into the display pixels when powering down the display.

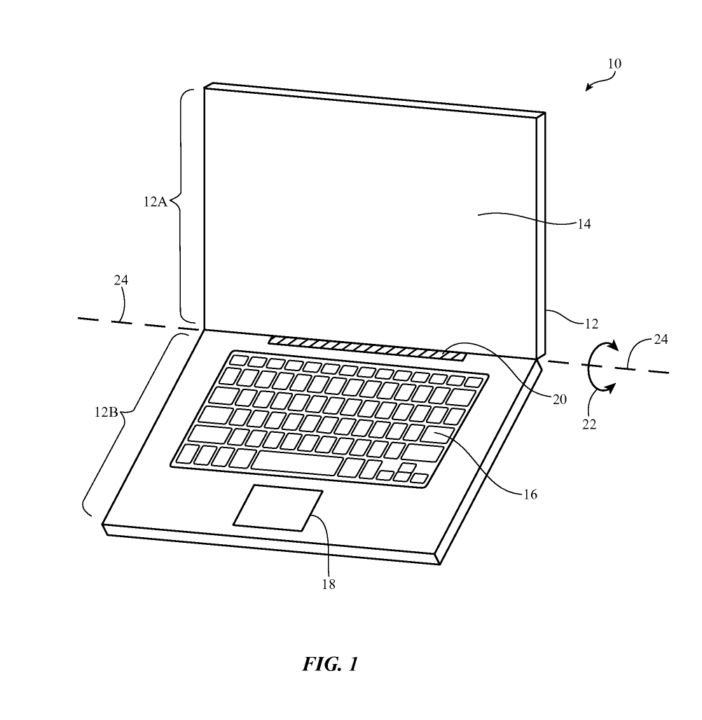

Illustrative electronic devices of the types that may be provided with displays having display driver circuitry that can load safe data during power-down operations are shown in FIGS. 1, 2, 3, and 4.

Electronic device 10 of FIG. 1 has the shape of a laptop computer and has upper housing 12A and lower housing 12B with components such as keyboard 16 and touchpad 18. Device 10 has hinge structures 20 (sometimes referred to as a clutch barrel) to allow upper housing 12A to rotate in directions 22 about rotational axis 24 relative to lower housing 12B. Display 14 is mounted in housing 12A. Upper housing 12A, which may sometimes be referred to as a display housing or lid, is placed in a closed position by rotating upper housing 12A towards lower housing 12B about rotational axis 24.

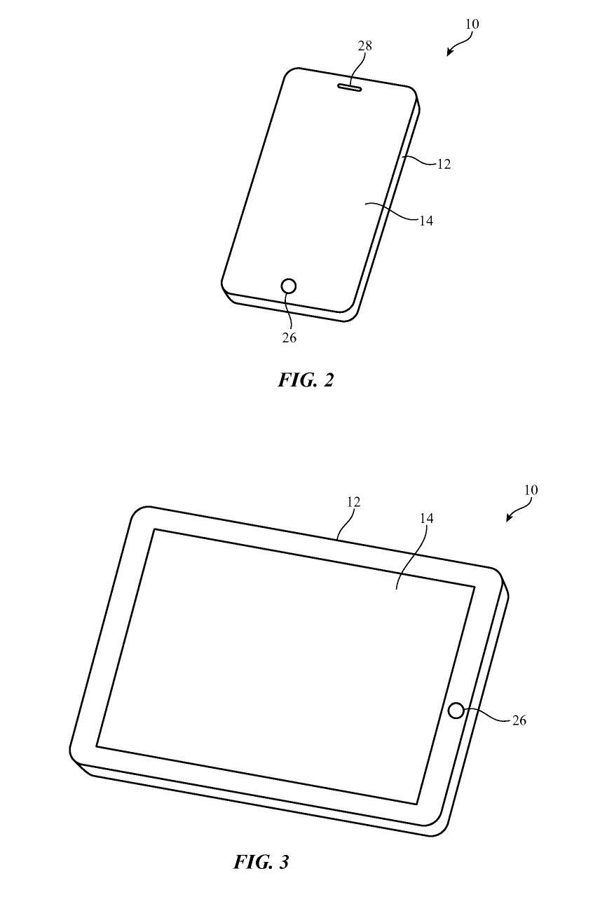

FIG. 2 shows an illustrative configuration for electronic device 10 based on a handheld device such as a cellular telephone, music player, gaming device, navigation unit, or other compact device. In this type of configuration for device 10, housing 12 has opposing front and rear surfaces. Display 14 is mounted on a front face of housing 12. Display 14 may have an exterior layer that includes openings for components such as button 26 and speaker port 28. Device 10 may, if desired, be a compact device such as a wrist-mounted device or pendant device (as examples).

In the example of FIG. 3, electronic device 10 is a tablet computer. In electronic device 10 of FIG. 3, housing 12 has opposing planar front and rear surfaces. Display 14 is mounted on the front surface of housing 12. As shown in FIG. 3, display 14 has an opening to accommodate button 26.

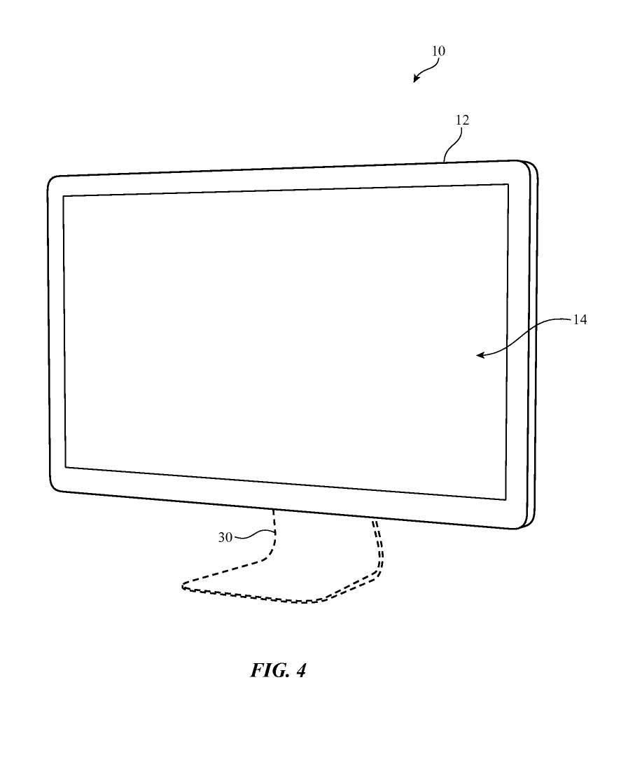

FIG. 4 shows an illustrative configuration for electronic device 10 in which device 10 is a computer display, a computer that has an integrated computer display, or a television. Display 14 is mounted on a front face of housing 12. With this type of arrangement, housing 12 for device 10 may be mounted on a wall or may have an optional structure such as support stand 30 to support device 10 on a flat surface such as a table top or desk.

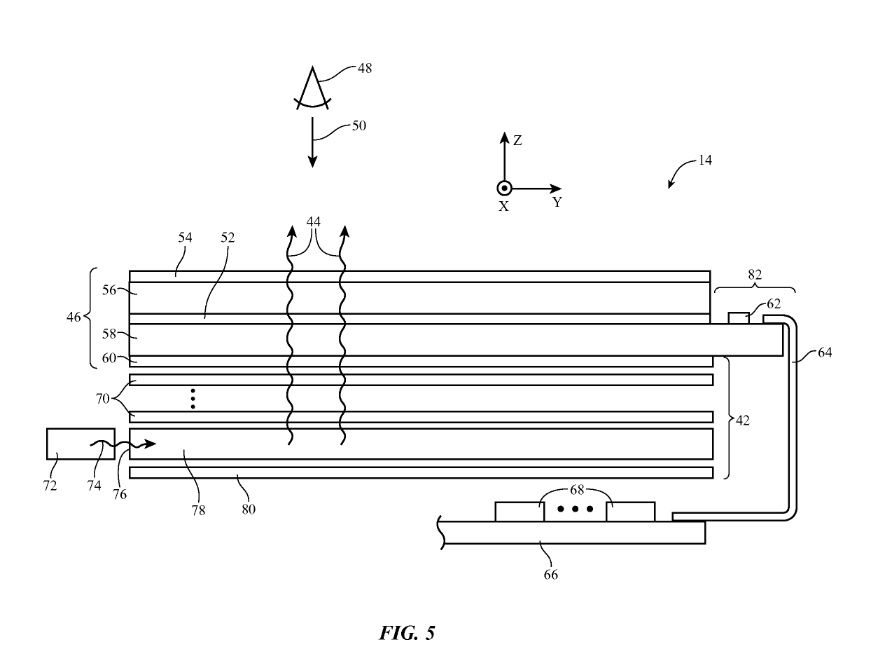

Display 14 may be a liquid crystal display, an organic light-emitting diode display, a plasma display, an electrophoretic display, an electrowetting display, a display using other types of display technology, or a display that includes display structures formed using more than one of these display technologies. A cross-sectional side view of an illustrative configuration for display 14 of device 10 (e.g., a liquid crystal display for the devices of FIG. 1, FIG. 2, FIG. 3, FIG. 4 or other suitable electronic devices) is shown in FIG. 5. As shown in FIG. 5, display 14 may include backlight structures such as backlight unit 42 for producing backlight 44. During operation, backlight 44 travels outwards (vertically upwards in dimension Z in the orientation of FIG. 5) and passes through display pixel structures in display layers 46. This illuminates any images that are being produced by the display pixels for viewing by a user. For example, backlight 44 may illuminate images on display layers 46 that are being viewed by viewer 48 in direction 50.

Display layers 46 may be mounted in chassis structures such as a plastic chassis structure and/or a metal chassis structure to form a display module for mounting in housing 12 or display layers 46 may be mounted directly in housing 12 (e.g., by stacking display layers 46 into a recessed portion in housing 12).

Display layers 46 may include a liquid crystal layer such a liquid crystal layer 52. Liquid crystal layer 52 may be sandwiched between display layers such as display layers 58 and 56. Layers 56 and 58 may be interposed between lower (innermost) polarizer layer 60 and upper (outermost) polarizer layer 54.

Layers 58 and 56 may be formed from transparent substrate layers such as clear layers of glass or plastic. Layers 56 and 58 may be layers such as a thin-film transistor layer and/or a color filter layer. Conductive traces, color filter elements, transistors, and other circuits and structures may be formed on the substrates of layers 58 and 56 (e.g., to form a thin-film transistor layer and/or a color filter layer). Touch sensor electrodes may also be incorporated into layers such as layers 58 and 56 and/or touch sensor electrodes may be formed on other substrates.

With one illustrative configuration, layer 58 may be a thin-film transistor layer that includes an array of thin-film transistors and associated electrodes (display pixel electrodes) for applying electric fields to liquid crystal layer 52 and thereby displaying images on display 14. Layer 56 may be a color filter layer that includes an array of color filter elements for providing display 14 with the ability to display color images. If desired, layer 58 may be a color filter layer and layer 56 may be a thin-film transistor layer.

During operation of display 14 in device 10, control circuitry (e.g., one or more integrated circuits on a printed circuit) may be used to generate information to be displayed on display 14 (e.g., display data). The information to be displayed may be conveyed to display driver circuitry 62 using signal path 64. Display driver circuitry 62 (which may sometimes be referred to as a display driver or timing controller and display driver circuitry) may include one or more integrated circuits such as column driver integrated circuits for driving data signals onto corresponding data lines in display 14, gate driver circuitry for supplying gate signals to gate lines in display 14, and a timing controller (TCON) integrated circuit that supplies image data to the column drivers and gate driver controls signals to the gate driver circuitry.

Backlight structures 42 may include a light guide plate such as light guide plate 78. Light guide plate 78 may be formed from a transparent material such as clear glass or plastic. During operation of backlight structures 42, a light source such as light source 72 may generate light 74. Light source 72 may be, for example, an array of light-emitting diodes.

Light 74 from light source 72 may be coupled into edge surface 76 of light guide plate 78 and may be distributed in dimensions X and Y throughout light guide plate 78 due to the principal of total internal reflection. Light guide plate 78 may include light-scattering features such as pits or bumps. The light-scattering features may be located on an upper surface and/or on an opposing lower surface of light guide plate 78.

Light 74 that scatters upwards in direction Z from light guide plate 78 may serve as backlight 44 for display 14. Light 74 that scatters downwards may be reflected back in the upwards direction by reflector 80. Reflector 80 may be formed from a reflective material such as a layer of white plastic or other shiny materials.

To enhance backlight performance for backlight structures 42, backlight structures 42 may include optical films 70. Optical films 70 may include diffuser layers for helping to homogenize backlight 44 and thereby reduce hotspots, compensation films for enhancing off-axis viewing, and brightness enhancement films (also sometimes referred to as turning films) for collimating backlight 44. Optical films 70 may overlap the other structures in backlight unit 42 such as light guide plate 78 and reflector 80. For example, if light guide plate 78 has a rectangular footprint in the X-Y plane of FIG. 5, optical films 70 and reflector 80 may have a matching rectangular footprint.

Display 14 may have an array of display pixels (e.g., a rectangular array having rows and columns) for displaying images to a viewer. Vertical signal lines called data lines may be used to carry display data to respective columns of display pixels. Horizontal signal lines called gate lines may be used to carry gate line signals (sometimes referred to as gate control signals or gate signals) to respective rows of display pixels.

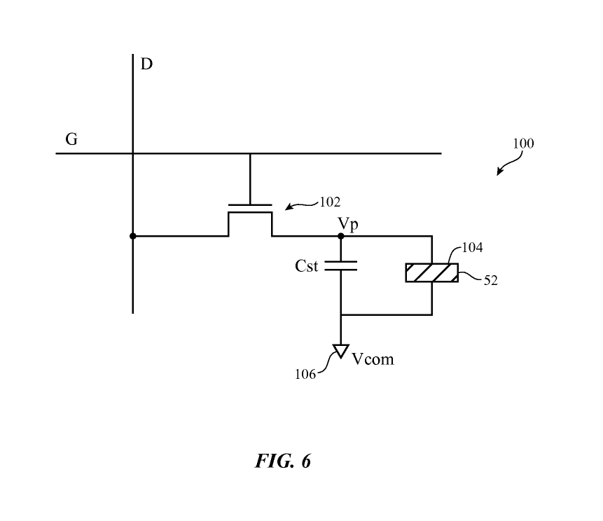

A circuit diagram of an illustrative display pixel is shown in FIG. 6. Data signals are provided to display pixel 100 over data line D. Gate signals are provided to display pixel 100 over gate line G. Common electrode voltage Vcom is applied to Vcom terminal 106. Storage capacitor Cst is used to store pixel voltage Vp between successive image frames. Display pixel 100 has electrodes 104 for applying an electric field to a pixel-sized portion of liquid crystal layer 52. The magnitude of the electric field that is provided to liquid crystal material 52 is proportional to Vp-Vcom.

Transistor 102 of display pixel 100 is used to control the loading of data signal D into storage capacitor Cst. When the gate signal on line G is asserted, transistor 102 is turned on and data line D supplies a desired value of voltage Vp to capacitor Cst. This voltage is applied to electrode 104 and serves to establish a desired electric field across liquid crystal layer 52.

The presence of persistent direct current (DC) voltages Vp on capacitor Cst (and therefore across liquid crystal layer 52) have the potential to permanently damage display 14 (e.g., by creating permanent images on the display corresponding to the last-loaded data frame). Transistor 102 may be a thin-film transistor formed from a semiconductor such as silicon (e.g., polysilicon) or a semiconducting oxide such as indium gallium zinc oxide. In some situations (e.g., polysilicon transistors), there can be non-negligible amounts of leakage current through transistor 102 when display 14 is powered down. This leakage current can effectively discharge any residual voltage Vp-Vcom across the pixel or capacitor Cst, thereby preventing damage to display 14 on power down events. In other situations (e.g., semiconducting oxide transistors), the leakage current through transistor 102 may be relatively low. In this type of scenario, it can be beneficial to actively drive safe data (e.g., data at a known safe voltage that will not damage display 14) into the display pixel array. For example, with a Vcom of 7.5 volts, a safe voltage of 7.5 volts can be actively loaded into each capacitor Cst in response to detection of an intentional or accidental power-down event so that the pixel voltage is zero, or alternatively Vcom can be set to zero and a safe voltage of zero loaded into each capacitor.

In intentional power-down events, there may be a substantial amount of time available to load safe data into the display pixels of display 14. In accidental power-down events, which may arise, for example, if line power or battery power to device 10 is unexpectedly interrupted, less time may be available. The type of power-down process that is used for device 10 may be configured to accommodate expected available power-down times. Rapid power-down protection schemes (e.g., schemes that accommodate power down events of a few ms or less or other rapid power down events) may be implemented by loading safe data into multiple rows of the display pixels in parallel. The most rapid types of power-down schemes may load numerous rows of display pixels with safe data at the same time. Less rapid types of power-down schemes (which may be used, for example, to avoid overly-large current surges in the display driver circuitry) may involve the loading of fewer rows of display pixels at a time (e.g., loading only two rows or one row with safe data at a time).

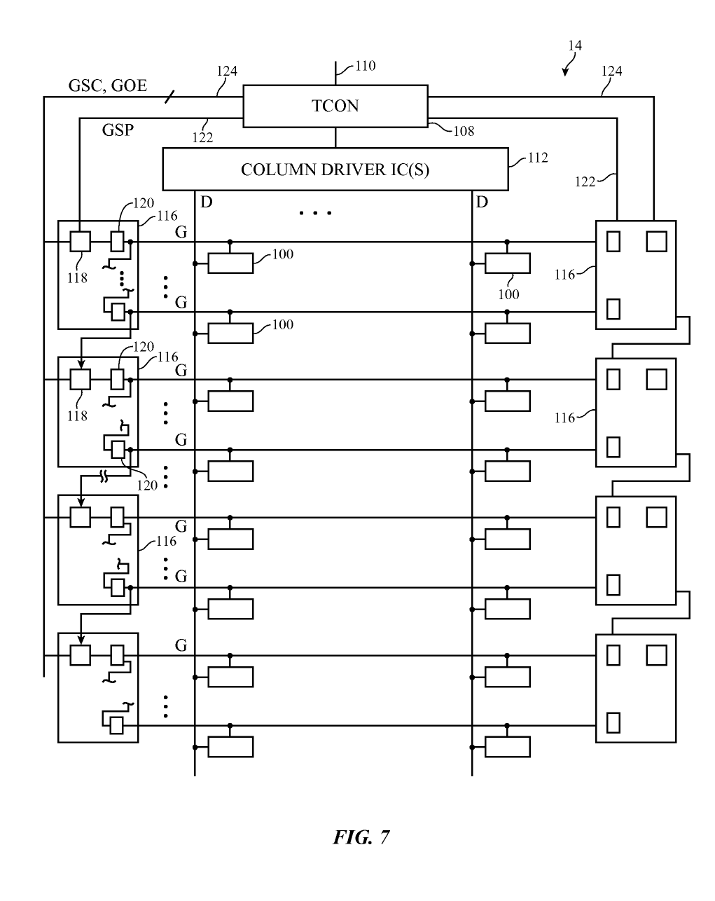

FIG. 7 is a circuit diagram for an illustrative display. As shown in FIG. 7, display 14 may include a rectangular array of display pixels 100. Columns of display pixels may be provided with data using respective data lines D. Rows of display pixels may be addressed using respective gate line signals on gate lines G. The display driver circuitry that is used in loading data into the display pixels of display 14 may include one or more integrated circuits and/or thin-film transistor circuitry. For example, the display driver circuitry may include a timing controller (TCON) integrated circuit such as circuit 108, one or more column driver (source driver) integrated circuits such as column driver circuitry 112, and gate driver circuitry such as gate driver integrated circuits 116. With one suitable arrangement, there is a respective gate driver integrated circuit 116 coupled to each end of each gate line G.

Each gate driver integrated circuit 116 may be used in supplying gate signals to a set of corresponding gate lines. There may be two or more, three or more, four or more, eight or more, or other suitable number of gate driver integrated circuits on each edge of display 14. Configurations in which gate driver circuitry is implemented using only gate driver integrated circuits 116 on the left or right edge of display 14 and/or arrangements in which gate driver circuitry is formed using thin-film transistors may also be used, if desired.

Timing controller circuit 108 may receive image data to be displayed on display 14 using path 110, which may be coupled to control circuitry on a main logic board or other circuitry in device 10. The image data may be processed by timing controller circuit 108 and supplied to column driver circuitry 112 so that column driver circuitry 112 can drive corresponding data signals onto data lines D. Timing controller circuit 108 may also supply gate driver control signals to gate driver circuitry 116. For example, timing controller circuit 108 may use a path such as path 122 to supply a gate start pulse signal GSP to circuits 116 and may use a path such as path 124 to supply control signals such as gate shift clock signal GSC and gate output enable signal GOE to circuits 116. Other sets of gate driver control signals may be used if desired (e.g., a control scheme involving multiple clocks may be used, etc.).

Gate driver circuits 116 may contain shift register circuitry formed from a chain of coupled register circuits 120. Mode selection circuits 118 may be used to place the gate driver circuitry of display 14 in one of two states. During normal operation, mode selection circuits 118 are placed in a normal state to apply gate control signals to shift register circuitry 120 in a way that loads a frame of image data sequentially into each row of display pixels 100 in display 14. During power-down operation, mode selection circuits 118 are placed in a power-down state that allows safe data to be loaded into multiple rows of display pixels 100 in parallel, thereby speeding up the process of safe data loading. This helps ensure that display pixels 100 can be satisfactorily loaded with safe data while sufficient power remains to operate the display driver circuitry.

During normal operations, the loading of each frame of image data may be initiated by assertion of signal GSP at the beginning of the frame. Signal GSC may be a square wave clock signal. During the loading of a frame of data, the gate signal on each gate line G in display 14 is asserted in sequence at the clock rate established by signal GSC. GSP paths between the last register circuit 120 in the shift register of each display driver integrated circuit 116 and the first register circuit 120 in the shift register of the next display driver integrated circuit 116 ensure that the asserted gate signal can propagate through each of the rows of the display in sequence (i.e., so that the gate signal in each of the rows of display 14 will be asserted one at a time in order, starting with the first row of the display and ending with the last row of the display). During normal operation, gate output enable signals GOE are used to protect the thin-film transistors 102 in display 14 from being driven during clock transitions.

During power-down operations, mode selection circuitry 118 is placed in a power-down state. In the power-down state, safe data is loaded into display pixels 100 in a desired pattern, balancing loading time versus current draw. As an example, multiple rows of display pixels (e.g., two or more rows, four or more rows, eight or more rows, etc.) may be loaded with safe data in parallel.

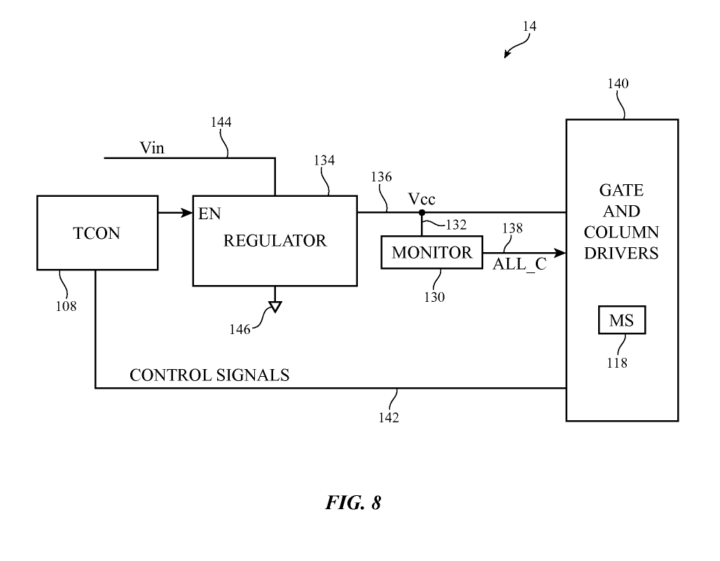

Control circuitry such as a voltage monitor circuit may be used to generate a control signal (which may, for example, be called mode selection signal ALL_C) that is used to control mode selection circuitry 118 upon power-down. FIG. 8 is a schematic diagram showing how monitor circuitry 130 may be used to monitor power supply signals in display 14. Display 14 may include voltage regulator circuitry such as voltage regulator circuitry 134. Voltage regulator circuitry may receive power supply input signals such as a positive input voltage Vin on path 144 and a ground voltage on path 146. Regulator 134 may produce a corresponding regulated positive power supply output voltage Vcc on path 136. Power supply voltage Vcc may be supplied to gate driver circuitry 116 and column driver circuitry 112 (i.e., gate and column drivers 140 of FIG. 8) using power supply path 136. If power is intentionally shut down or if power is accidentally interrupted due to an interruption in line power or battery power, the magnitude of regulated power supply voltage Vcc will drop. Monitor circuit 130 monitors the magnitude of voltage Vcc in real time using input 132. For example, monitor circuit 130 may compare measured Vcc values to a predetermined normal power supply threshold voltage. When display 14 is operating normally and is fully powered, monitor circuit 130 will deassert mode selection signal ALL_C on output 138 (i.e., ALL_C can be held high or otherwise deasserted so long as power supply Vcc is above the predetermined threshold value). In response to detecting that voltage Vcc has dropped below the threshold as part of a power-down event, monitor 130 will conclude that display 14 is losing power and will assert mode selection signal ALL_C (i.e., mode selection signal ALL_C can be taken low). Mode selection signal ALL_C is received by mode selection circuitry 118 in driver circuitry 140. Monitor circuit 130 may be implemented as part of TCON circuit 108, column driver circuitry 112, gate driver circuits 116, or other circuitry in device 10 (e.g., other display driver circuitry, etc.).

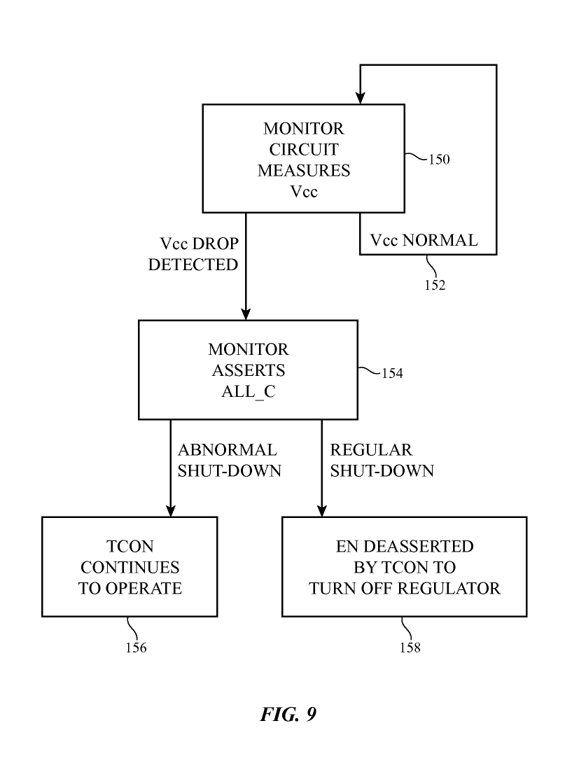

FIG. 9 is a flow chart of illustrative power-down operations performed using the circuitry of FIG. 9 in powering down display 14. At step 150, monitor 130 monitors voltage Vcc. In response to determining that Vcc is within its normal operating range, monitoring continues, as indicated by line 152. In response to determining that Vcc has dropped below its normal operation range, monitor 130 asserts mode selection signal ALL_C at step 154.

In intentional power-down scenarios, TCON 108 deasserts an enable signal EN to disable regulator 134 (FIG. 8). In accidental power-down scenarios, TCON 108 does not deassert signal EN (step 156). Regardless of whether power-down operations are initiated intentionally or whether power-down operations result from power supply disruption, timing controller 108 may continue to supply control signals (e.g. GSP, GSC, GOE) to circuitry 140 over path 142 during power-down, which allows safe data to be loaded into the display pixels.

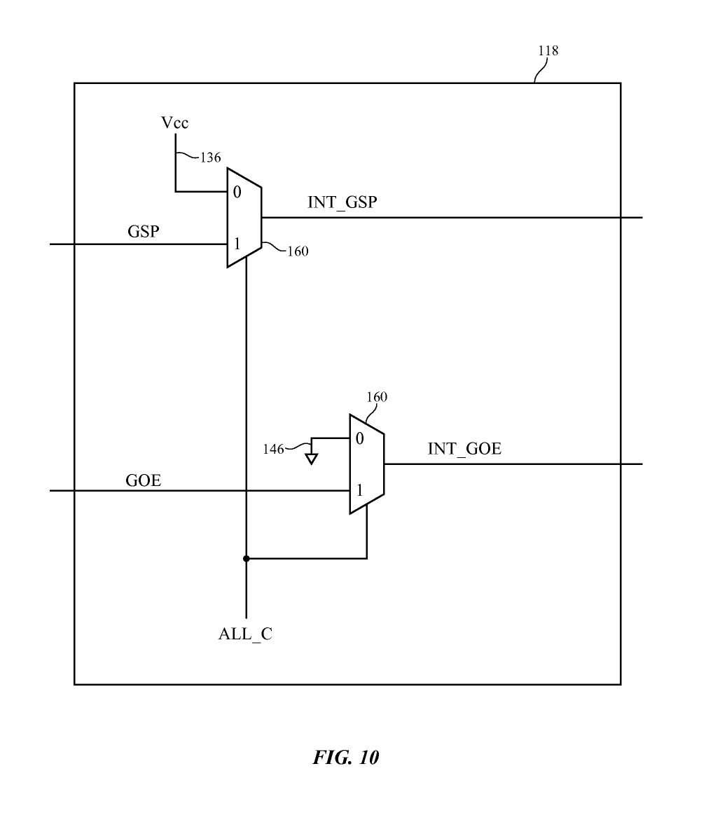

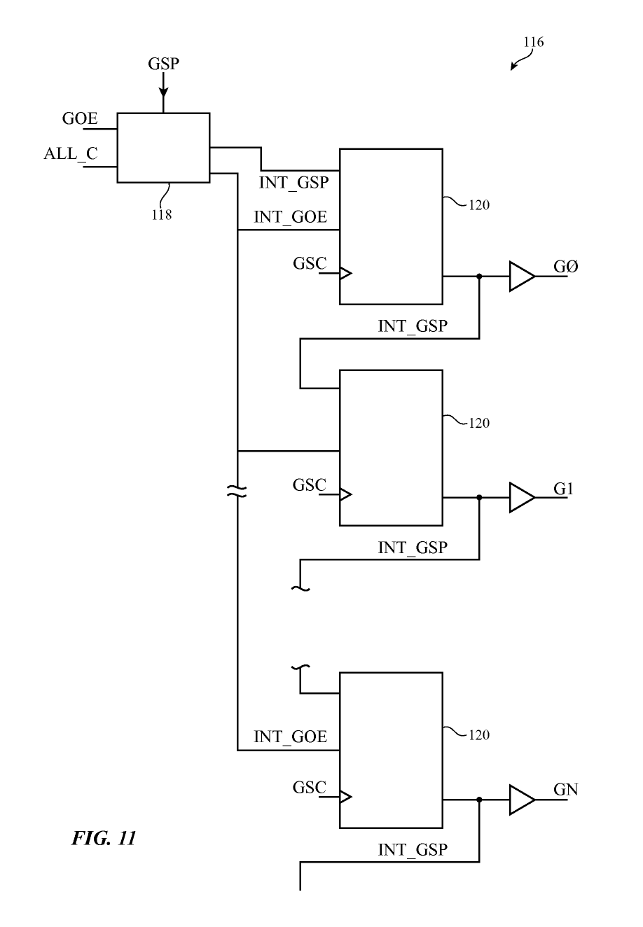

An illustrative mode selection circuit 118 (i.e., a mode selection circuit that may be provided in each of the gate driver integrated circuits 116) is shown in FIG. 10. Mode selection circuitry 118 may receive signals GSP and GOE as inputs. For example, each mode selection circuit may receive a corresponding GOE signal from TCON circuit 108. The GSP signal that is received by the mode selection circuit 118 in the uppermost gate driver integrated circuits 116 on the left and right of display 14 may be received from TCON circuit 108. Subsequent mode selection circuits 118 (i.e., mode selection circuits 118 in the gate driver integrated circuits 116 below the uppermost gate driver integrated circuits) receive their GSP inputs from the output of a previous gate driver integrated circuit 116.

As shown in FIG. 10, the GSP signal that is received as an input to each mode selection circuit 118 is output from that circuit 118 as internal GSP signal INT_GSP. The INT_GSP signal in a given gate driver integrated circuit is propagated down through the shift register circuitry 120 of that gate driver integrated circuit and is then passed downwards to the next gate driver integrated circuit (i.e., the associated circuit 116 on the left or right edge of display 14 that lies just below the given gate driver integrated circuit) to use as a GSP input.

The gate output signal GOE that is supplied to each mode select circuit 118 is output as corresponding internal gate output enable signal INT_GOE, which is applied to the shift register circuitry.

The state of mode selection signal ALL_C from monitor 130 determines the behavior of multiplexing circuitry 160. During normal operation, signal ALL_C is deasserted (e.g., ALL_C is high), so input signal GSP is provided to the output of mode selection circuit 118 as INT_GSP. This signal may propagate downward through the shift registers of display 14 to control which row of display pixels 100 is currently receiving an asserted gate line signal (while all other rows are receiving deasserted gate line signals). During normal operation, the gate output enable signal (i.e., INT_GOE) is supplied to the shift register circuitry 120 to help protect the thin-film transistors in the display pixels from being driven during transitions of clock GSC.

During power-down operations, signal ALL_C is asserted (e.g., ALL_C is taken low). In this situation, signal GSP is held high at Vcc and signal GOE is held low.

FIG. 11 is a circuit diagram of an illustrative gate driver integrated circuit 116. As shown in FIG. 11, gate driver integrated circuit 116 may have a shift register formed from a chain of register circuits 120. Each register circuit 120 receives GSP, GOE, and GSC signals and supplies a corresponding gate signal output (i.e., a gate output signal for gate line G0 in the first row of the display, a gate output signal for gate line G1 in the second row of the display, etc.). Each gate driver integrated circuit 116 has an associated mode selection circuit 118. That mode selection circuit 118 has a control input that receives mode selection signal ALL_C, inputs that receive signals GOE and GSP, and outputs at which corresponding INT_GSP and INT_GOE signals are provided to the shift register circuitry of the gate driver integrated circuit.

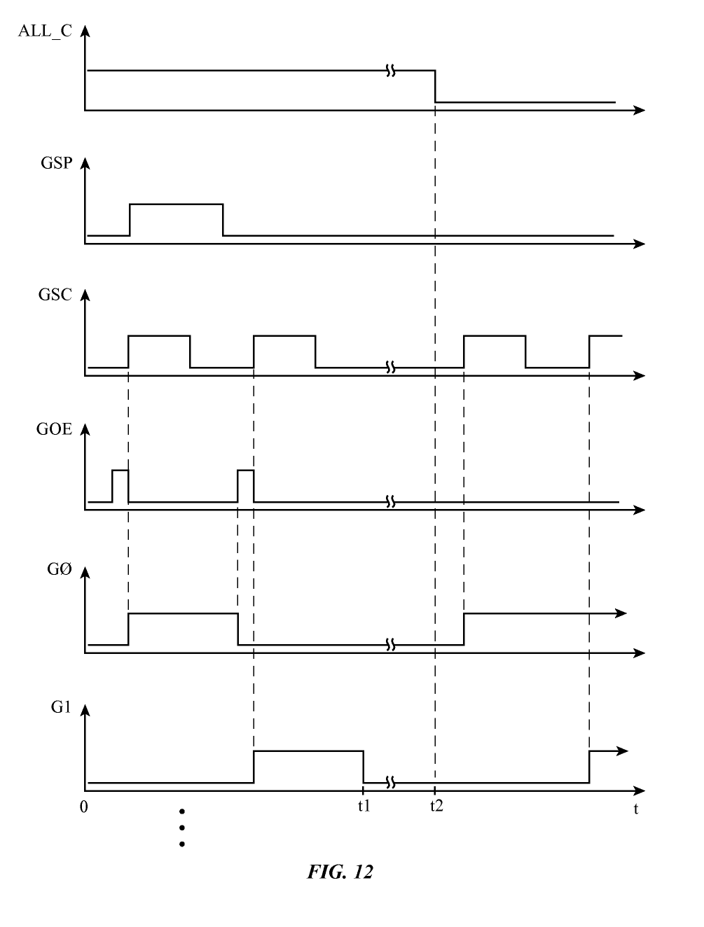

Timing diagrams that illustrate the operation of the display driver circuitry of display 14 during normal operation and during power-down operations are shown in FIG. 12. The uppermost four traces in FIG. 12 correspond to control signals GSP, GSC, GOE, and ALL_C. The lowermost two traces of FIG. 12 correspond to two of the gate line signals in display 14 (i.e., the gate signal G0 for the first row of display pixels in display 14 and the gate signal G1 for the second row of display pixels in display 14). Additional gate signals (not shown in FIG. 12) are associated with the remaining rows of display 14.

In the graphs of FIG. 12, the signals between time t=0 and time t=t1 are associated with normal operation of display 14. The signals after time t=t2 correspond to power-down operation.

During normal operation, signal GSP is asserted (e.g., taken high) at the start of the loading of each new frame of image data into the array of display pixels in display 14. Clock GSC and gate output enable signals GOE are used by shift register circuitry 120 to create a sequence of gate signals on the gate lines. As shown in FIG. 12, initially gate signal G0 is asserted while all remaining gate signals are deasserted. Then gate signal G1 is asserted and the other gate signals, including gate signal G0 are deasserted. This gate signal assertion process cascades sequentially through all of the gate lines until repeating for the next frame of data. Mode selection signal ALL_C (an active low signal in this example) is deasserted (held high) during normal operation, indicating that mode selection circuitry 118 is held in its normal state.

During a power-down event, power supply voltage Vcc drops below its normal level. At time t2, monitor 130 detects that Vcc has dropped below a predetermined threshold. In response, monitor 130 asserts ALL_C (i.e., ALL_C is taken low, as shown in FIG. 12). Each gate line signal is then asserted in series and is maintained in this asserted state once asserted. For example, gate signal G0 is asserted and then, following assertion of gate signal G0, gate signal G1 is asserted without deasserting gate signal G0. Subsequent gate signals are asserted one after another in the same way. As each gate line signal is asserted, TCON circuit 108 and column drivers 112 supply a safe voltage to the data lines D in display 14 to load safe data into the display pixels of the row associated with the asserted gate line signal (e.g., a safe voltage such as 7.5 volts). By loading all rows of display 14 with safe data in this way, damage to display 14 following power down may be avoided.

Safe data can be loaded into one or more rows of display pixels at a time, but preferably fewer than all of the rows of data are loaded at once. By ensuring that only a subset of the rows of display 14 are loaded during any given clock cycle, excessively large current values will not be drawn by the display driver circuitry during power-down events.

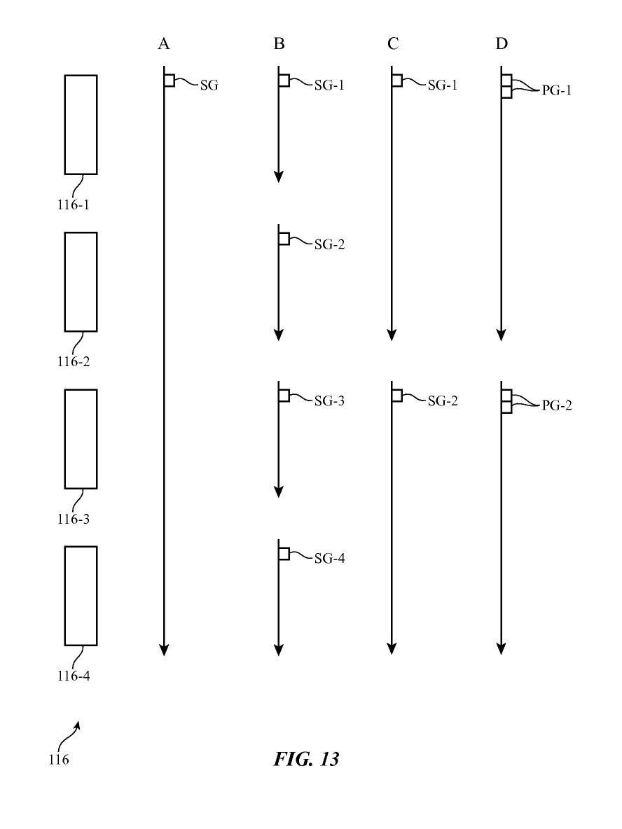

FIG. 13 shows several illustrative safe data loading patterns that may be used when asserting the gate signals in the rows of display 14 while loading safe data into display pixels during power down operations. In the illustrative example of FIG. 13, display 14 has four gate driver circuits 116 (gate driver circuit 116-1, gate driver 116-2, gate driver 116-3, and gate driver 116-4). Each of gate driver circuits 116 may drive signals into a plurality of associated rows of display pixels (i.e., the gate line outputs of each circuit 116 may be coupled to a corresponding set of gate lines).

There may be gate driver circuits 116 on both ends of each gate line. In this type of double-ended arrangement, there is a possibility of undesirable contention between the gate drivers on opposing ends of a gate line during power down operations. This situation can be avoided by ensuring that both the left-hand gate driver integrated circuits and the right-hand gate driver integrated circuits of display 14 are driven by a common clock signal GSC during power down (i.e., contention can be avoided by driving the left and right gate driver circuits synchronously during power down operations).

Illustrative pattern A of FIG. 13 corresponds to a scenario in which a single gate line (gate line SG) is asserted in sequence, running through all of the rows output by gate driver integrated circuits 116-1, 116-2, 116-3, and 116-4, starting with the first row output by gate driver integrated circuit 116-1 and ending with the last line output by gate driver integrated circuit 116-4. Use of this type of pattern may minimize current draw by the display driver circuitry during a power down event, because no more than one gate line is being driven at any given time, but will also consume about a full frame time before power-down operations are complete.

Illustrative pattern B of FIG. 13 corresponds to a scenario in which four gate lines are asserted in parallel when powering down. As shown in FIG. 13, a single gate line SG-1 is asserted at a time by gate driver integrated circuit 116-1, a single gate line SG-2 is asserted at a time by gate driver integrated circuit 116-2, a single gate line SG-3 is asserted at a time by gate driver integrated circuit 116-3, and a single gate line SG-4 is asserted at a time by gate driver integrated circuit 116-4. This is achieved by using ALL_C and GSP to generate INT_GSP. Initially, circuits 116-1, 116-2, 116-3, and 116-4 each assert the gate line signal on the gate line in the first row output by that circuit. Subsequently, each circuit asserts the gate line signal on the gate line in the second row output by that circuit. In sequence, each gate driver integrated circuit asserts all of its gate line outputs, one at a time. But because four gate driver integrated circuits are synchronously sequencing through their gate line outputs at the same time, safe data is loaded into the display in parallel four times faster than the arrangement of pattern A. The arrangement of pattern B therefore reduces the total time need to load the display with safe data significantly (i.e., by a factor of four relative to the arrangement of pattern A). The ability to complete the safe data loading operation rapidly is advantageous because it helps avoid a situation in which TCON 108 is starved of power a short time after power down starts and therefore can only generate satisfactory gate driver control signals for use in loading the safe data for a short time.

Pattern C of FIG. 13 corresponds to a scenario in which a first set of gate driver integrated circuits (circuits 116-land 116-2) sequentially assert a first gate line signal SG-1 while in parallel a second set of gate driver integrated circuits (circuits 116-3 and 116-4) sequentially assert a second gate line signal SG-2. There is less parallelism involved when loading safe data into the display in the scenario of pattern C (in which data is loaded into two rows in parallel) than in the scenario of pattern B (in which data is loaded into four rows in parallel). This increases (by a factor of two) the total amount of time needed to load the display with safe data during power down, but also reduces (by half) the peak current drawn by the display driver circuitry during power down.

If desired, each display driver integrated circuit may be configured to load safe data into the display two rows at a time (i.e., multiple rows may be loaded in parallel using a common gate driver integrated circuit). As shown by illustrative power-down row pattern D of FIG. 13, for example, gate signals for a pair of rows PG-1 may be asserted at the same time. This pair of rows may be sequentially incremented through all of the output rows (e.g., using a serial top-to-bottom pattern of the type shown by pattern A in the single-row example) or may, as illustrated in pattern D, form part of a parallel loading arrangement in which multiple gate driver circuits are used in parallel. With the approach illustrated by pattern D, a first set of gate driver integrated circuits (116-1 and 116-2) may be used to sequentially assert gate signal pair PG-1 on the rows associated with the first set of gate driver integrated circuits while in parallel a second set of gate driver integrated circuits (116-3 and 116-4) sequentially assert gate signal pair PG-2 on the rows associated with the second set of gate drivers. As the pattern D example illustrates, safe data loading parallelism may be implemented by asserting gate line signals using multiple respective gate driver integrated circuits in parallel (see, e.g., pattern B), by configuring each gate driver integrated circuit to assert two or more gate signals in parallel, or both (see, e.g., pattern D).

The foregoing is merely illustrative and various modifications can be made by those skilled in the art without departing from the scope and spirit of the described embodiments. The foregoing embodiments may be implemented individually or in any combination.

What is claimed is:

1. A display, comprising:
an array of display pixels; and
display driver circuitry including column driver circuitry and gate driver circuitry, wherein the display driver circuitry is configured to:
load image data that is to be displayed on the display into the array of display pixels during normal operation; and
load safe data into the array of display pixels during power-down operations to prevent damage to the array of display pixels.

2. The display defined in claim 1 wherein the gate driver circuitry comprises a plurality of gate driver integrated circuits and wherein each gate driver integrated circuit comprises a mode selection circuit, wherein the mode selection circuits are placed in a normal operating state when a mode selection signal is deasserted and are placed in a power-down operating state when the mode selection signal is asserted.

3. The display defined in claim 2 further comprising data lines with which the column circuitry loads the display pixels and gate lines with which rows of the display pixels are addressed.

4. The display defined in claim 3 further comprising a monitor circuit that monitors a power supply voltage on a power supply line and produces the mode selection signal based on a measured value of the power supply voltage.

5. The display defined in claim 4 further comprising a regulator that supplies the power supply voltage to the power supply line, wherein the monitor is configured to deassert the mode selection signal in response to determining that the power supply voltage is above a given threshold and is configured to assert the mode selection signal in response to determining that the power supply voltage is below the given threshold.

6. The display defined in claim 5 wherein the display driver circuitry is configured to load the image data into the array of display pixels one row at a time during normal operation and is configured to load the safe data into multiple rows of the array of display pixels in parallel during power-down operations.

7. The display defined in claim 6 wherein each of the gate driver integrated circuits is configured to simultaneously load the safe data into the multiple rows of the array.

8. The display defined in claim 6 wherein the display driver circuitry is configured so that safe data is simultaneously loaded into multiple rows of the array by loading at least a first row of the array with a first one of the gate driver integrated circuits while simultaneously loading at least a second row of the array with a second one of the gate driver integrated circuits.

9. A method of operating a display having an array of display pixels coupled to timing controller and display driver circuitry, comprising:
during normal operation, loading image data to be displayed on the array of display pixels into the array of display pixels using the timing controller and display driver circuitry; and
during power down operations, loading safe data into the array of display pixels using the timing controller and display driver circuitry to avoid damaging the display.

10. The method defined in claim 9 wherein the array of display pixels has a given number of rows and wherein loading the safe data into the array of display pixels comprises loading fewer rows at a time with the safe data than the given number of rows.

11. The method defined in claim 9 wherein loading the safe data into the array of display pixels comprises loading at least two rows of the display pixels with safe data in parallel.

12. The method defined in claim 11 wherein loading the two rows of display pixels with safe data in parallel comprises using multiple gate driver integrated circuits in the gate driver circuitry to load respective rows of display pixels with the safe data.

13. The method defined in claim 11 wherein loading the two rows of display pixels with safe data in parallel comprises loading multiple rows of display pixels in parallel using a common gate driver integrated circuit in the gate driver circuitry.

14. The method defined in claim 9 wherein the timing controller and display driver circuitry includes mode selection circuitry and shift register circuitry and wherein loading the image data using the timing controller and display driver circuitry comprises placing the mode selection circuitry in a first state and, while the mode selection circuitry is in the first state, sequentially asserting a gate signal in each of the rows using the shift register circuitry while data lines are set to desired pixel data values.

15. The method defined in claim 14 wherein loading the safe data comprises placing the mode selection circuitry in a second state and, while the mode selection circuitry is in the second state, asserting gate signals in multiple rows in parallel using the shift register circuitry while data lines are set to safe data values.

16. The method defined in claim 15 further comprising:
monitoring a power supply voltage; and
in response to detecting a decrease in the power supply voltage, placing the mode selection circuitry in the second state.

17. A display, comprising:
an array of display pixels;
a timing controller integrated circuit that generates gate driver control signals;
column driver circuitry with which the timing controller supplies signals to columns of display pixels in the array of display pixels; and
gate driver circuitry that receives the gate driver control signals from the timing controller, wherein the gate driver circuitry is configured to load data into the display pixels in response to detecting a power down event in which the display is being powered down.

18. The display defined in claim 17 wherein the display pixels comprise liquid crystal display pixels each of which includes a semiconducting oxide thin-film transistor.

19. The display defined in claim 18 further comprising:
a regulator that supplies a power supply voltage; and
a monitor circuit that monitors the power supply voltage and that produces a corresponding mode selection signal indicative of detection of the power down event upon measuring that the power supply voltage has dropped below a predetermined threshold voltage, wherein the gate driver circuitry comprises circuitry responsive to the mode selection signal.

20. The display defined in claim 19 wherein the circuitry that is responsive to the mode selection circuitry comprises multiplexer circuitry that receives a gate start pulse signal.
